(19) United States
(12) Patent Application Publication
(10) Pub. No.: US 2008/0165000 A1
(43) Pub. Date: Jul. 10, 2008

(54) Suppression of False Alarms in Alarms Arising from Intrusion Detection Probes in a Monitored Information System

(75) Inventors: Benjamin Morin, Rennes (FR); Herve Debar, Louvigny (FR)

Correspondence Address: COHEN, PONTANI, LIEBERMAN & PAVANE, 551 FIFTH AVENUE, SUITE 1210, NEW YORK, NY, 10176, US

(73) Assignee: FRANCE TELECOM, Paris (FR)

(21) Appl. No.: 11/579,901

(22) PCT Filed: May 9, 2005
(86) PCT No.: PCT/FR05/01142

§ 371 Date: Oct. 19, 2007

(30) Foreign Application Priority Data
May 10, 2004 (FR) 0405013

(51) Int. Cl. G08B 13/00

(52) U.S. Cl. 340/541

(57) ABSTRACT

The invention relates to a system and a method of suppressing false alarms among alarms issued by intrusion detection sensors (13a, 13b, 13c) of a protected information system (1) including entities (9, 11a, 11b) generating attacks associated with the alarms and an alarm management system (15), the method comprising the following steps:
using a false alarm suppression module (23) to define qualitative relationships between the entities (9, 11a, 11b) and a set of profiles;
using the false alarm suppression module (23) to define nominative relationships between the set of profiles and a set of names of attacks which that set of profiles is recognized as generating; and
using the false alarm suppression module (23) to qualify a given alarm as a false alarm if the entity (9, 11a, 11b) implicated in the given alarm has a profile recognized as generating the attack associated with that given alarm.

### BACKGROUND OF THE INVENTION

The invention relates to a system and a method of suppressing false alarms among alarms issued by intrusion detection sensors.

The security of information systems relies on deploying intrusion detection systems. These intrusion detection systems are situated on the upstream side of intrusion prevention systems. They are used to detect activities contravening the security policy of an information system.

Intrusion detection systems include intrusion detection sensors that send alarms to alarm management systems.

The intrusion detection sensors are active components of the intrusion detection system that analyze one or more sources of data to discover events characteristic of an intrusive activity and to send alarms to the alarm management systems. An alarm management system centralizes alarms coming from the sensors and where appropriate analyses all of them.

Intrusion detection sensors generate a very large number of alarms, possibly several thousand a day, as a function of configurations and the environment.

The surplus alarms are mainly false alarms. 90% to 99% of the thousands of alarms generated daily in an information system are generally false alarms.

Analysis of the causes of these false alarms shows that it is very often a question of erratic behavior of entities (for example servers) of the protected network. It may also be a question of normal behaviors of entities when that activity resembles an intrusive activity, so that the intrusion detection sensors issue alarms by mistake.

Since by definition normal behaviors constitute the majority of the activity of an entity, the false alarms they generate are recurrent and make a major contribution to the overall surplus of alarms.

### OBJECT AND SUMMARY OF THE INVENTION

An object of the invention is to remove these drawbacks and to provide a simple method of suppressing false alarms among alarms issued by intrusion detection sensors to enable fast and easy diagnosis of real alarms.

These objects are achieved by a method of suppressing false alarms among alarms issued by intrusion detection sensors of a protected information system including entities generating attacks associated with the alarms and an alarm management system, the method being characterized in that it comprises the following steps:
defining qualitative relationships between the entities and a set of profiles;
defining nominative relationships between the set of profiles and a set of names of attacks which that set of profiles is recognized as generating; and
using a false alarm suppression module to quality a given alarm as a false alarm if the entity implicated in the given alarm has a profile recognized as generating the attack associated with that given alarm.

Accordingly, eliminating false alarms implicating entities of the network having profiles recognized as generating false alarms provides a real and accurate view of activities compromising the security of the information system.

Each entity may be an attacker or a victim.

The false alarm suppression module advantageously defines the qualitative relationships by successively inferring new qualitative relationships, so that if a given entity is implicated in alarms associated with a given attack according to a first statistical criterion, and if that given entity does not have a profile recognized as generating the given attack, then the false alarm suppression module infers a new qualitative relationship by allocating said profile recognized as generating the given attack to said given entity.

According to a feature of the invention, the first statistical criterion verifies whether the frequency of alarms implicating said given entity is greater than an alarm threshold frequency associated with said given attack.

The false alarm suppression module advantageously defines the nominative relationships by successively inferring new nominative relationships, so that if a given profile is common to a plurality of entities implicated in alarms associated with a particular attack according to a second statistical criterion, and there is no profile recognized as generating that particular attack, then the false alarm suppression module infers a new nominative relationship by allocating said particular attack to said given profile.

According to another feature of the invention, the second statistical criterion verifies whether the frequency of said particular attack is higher than an alarm threshold frequency.

The qualitative relationships may be stored in a first database and the nominative relationships may be stored in a second database, optionally after they have been validated by a security operator.

Some of the qualitative and nominative relationships are preferably defined explicitly by the security operator.

The false alarm is advantageously forwarded to the alarm management system.

The invention is also directed to a false alarm suppression module including data processor means for defining qualitative relationships between entities and a set of profiles, for defining nominative relationships between the set of profiles and a set of names of attacks which that set of profiles is recognized as generating, and for qualifying a given alarm as a false alarm if the entity implicated in the given alarm has a profile recognized as generating the attack associated with that given alarm.

The module advantageously further includes memory means for storing the qualitative relationships in a first database and for storing the nominative relationships in a second database.

The module may further include an output unit for use by a security operator to validate the qualitative and nominative relationships.

According to a feature of the invention, the module is connected between an alarm management system and intrusion detection sensors issuing alarms associated with attacks generated by the entities.

The invention is also directed to a protected information system including entities, intrusion detection sensors, an alarm management system, and a false alarms suppression module having the above features.

### BRIEF DESCRIPTION OF THE DRAWINGS

Other features and advantages of the invention emerge on reading the following description given by way of non-limiting example with reference to the appended drawings, in which:

FIG. 1 is a highly schematic view of a protected information system including a false alarm suppression module according to the invention, and

FIG. 2 is a flowchart showing the steps of a method in accordance with the invention of suppressing false alarms among alarms issued by intrusion detection sensors.

### DETAILED DESCRIPTION OF EMBODIMENTS

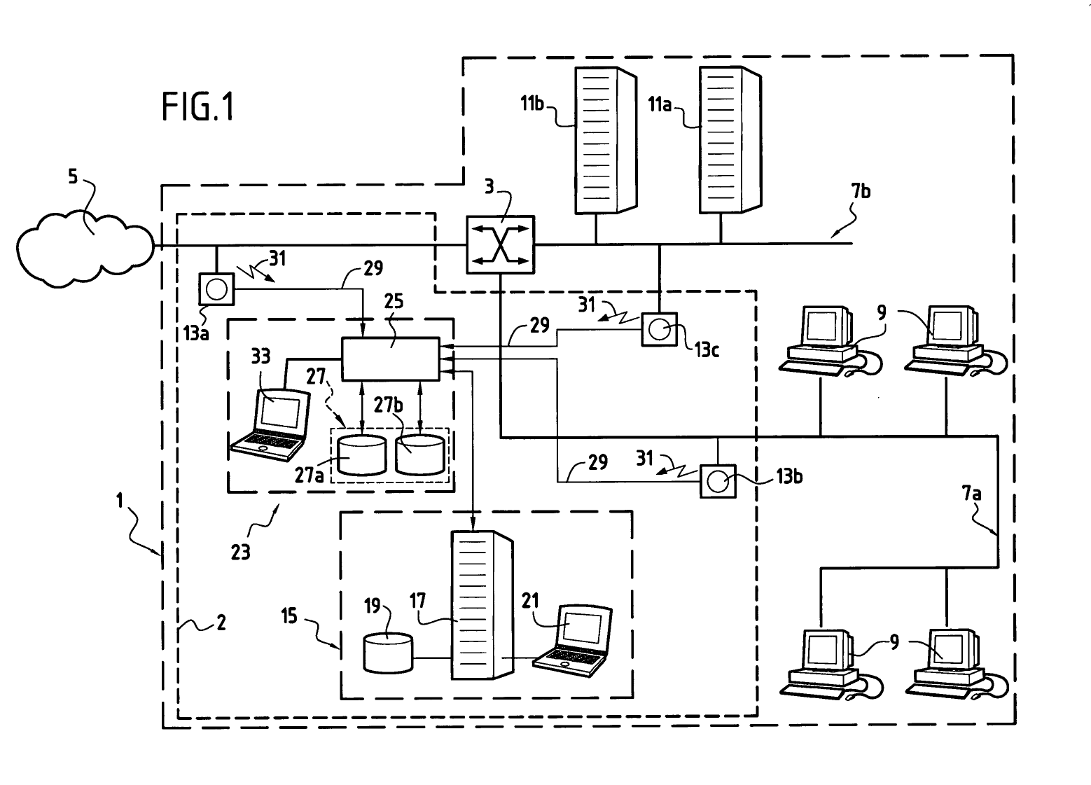

FIG. 1 shows an example of a protected information system or network 1 including a protection system 2, a router 3, and a distributed architecture internal network 7a and 7b. The protection system 2 is connected via the router 3 to an external network 5 and to the internal network 7a and 7b.

The protected information system 1 comprises a set of entities, for example workstations 9, servers 11a, web proxies 11b, etc. The protection system 2 includes a plurality of intrusion detection sensors 13a, 13b, 13c that issue alarms 31 if attacks are detected and an alarm management system 15 adapted to analyze alarms issued by the sensors 13a, 13b, 13c.

Accordingly, a first intrusion detection sensor 13a monitors external attacks, a second sensor 13b monitors a portion 7a of the internal network comprising workstations 9, and a third sensor 13c monitors another portion 7b of the internal network comprising servers 11a, 11b communicating with the external network 5.

The alarm management system 15 includes a host 17 dedicated to processing alarms, storage means 19 and an output unit 21.

According to the invention, the protected information system 1, more particularly the protection system 2, includes a false alarm suppression module 23 connected to the intrusion detection sensors 13a, 13b, 13c and to the alarm management system 15. The false alarm suppression module 23 therefore provides a break point between the intrusion detection sensors 13a, 13b, 13c and the alarm management system 15.

Generally speaking, the intrusion detection sensors 13a, 13b, 13c generate a large number of false alarms that are often caused by normal behaviors of the entities 9, 11a, 11b that resemble attacks. The present invention therefore proposes firstly associating with profiles the attacks that those profiles are recognized as generating, and secondly associating with the entities 9, 11a, 11b of the protected information system 1 particular profiles that are linked thereto in relation to their function (for example the web proxy function). These two associations serve to eliminate alarms known to be false alarms.

The false alarm suppression module 23 is then adapted to have the following three functions:

1. Inferring qualitative relationships between the entities 9, 11a, 11b of the protected information system 1 and a set of profiles. For example, if an entity 9, 11a, 11b generates a large number of instances of an attack and there is a profile recognized as generating that attack, but the entity does not have that profile, then the false alarm suppression module 23 automatically infers that the entity 9, 11a, 11b has the profile in question.

2. Inferring nominative relationships between all of the profiles and a set of names of attacks which that set of profiles is recognized as generating. For example, if there exist a large number of instances of a particular attack, and there is no profile recognized as generating that attack, but the entities 9, 11a, 11b implicated in the alarms corresponding to the attack all have certain profiles in common, then the false alarm suppression module 23 automatically infers that the common profiles are generating the attack in question.

3. Recognizing a false alarm by qualifying a given alarm 31 as a false alarm if the entity 9, 11a, 11b implicated in the given alarm has a profile recognized as generating the attack associated with the given alarm 31.

To this end, the false alarm suppression module 23 comprises data processor means 25 for establishing and processing these relationships and memory means 27 for storing the qualitative relationships in a first database 27a and for storing the nominative relationships in a second database 27b. A computer program designed to implement the present invention may be executed by the processor means 25 of the false alarm suppression module 23.

Accordingly, the sensors 13a, 13b, 13c deployed in the protection system 2 send their alarms 31 to the false alarm suppression module 23 over links 29. According to the invention, this module proceeds to eliminate false alarms according to the two types of relationship available.

Note that some of the qualitative and nominative relationships may be defined explicitly by a security operator.

Similarly, the security operator may be requested to validate or confirm the qualitative and nominative relationships inferred by the false alarm suppression module 23. The security operator can validate these relationships via the output unit 21 of the alarm management system 15, or if appropriate via another output unit 33 included in the false alarm suppression module 23.

Accordingly, each alarm instance 31 generated by an intrusion detection sensor 13a, 13b, 13c is submitted to the false alarm suppression module 23 for analysis. In the above case 1, and where applicable after validation by the security operator, the association between the entity 9, 11a, 11b and the suggested profile is stored in the first database 27a. In case 2, and where applicable after validation by the security operator, the association between the profile and the attack is stored in the second database 27b. In case 3, the false alarm suppression module 23 qualifies the alarm as a false alarm.

The interaction between the false alarm suppression module 23 and the alarm management system 15 enables the system 15 to store only real alarms in the storage means 19. Consequently, these real alarms may be consulted accurately, quickly, and simply via the output unit 21.

By eliminating false alarms, the false alarm suppression module 23 considerably reduces the number of alarms that have to be processed by the alarm management system 15.

Generally speaking, the entities 9, 11a, 11b of the protected information system 1 are the cause of the false alarms.

Consider the example of a “web proxy” server 11b that is seeking to relay user HTTP requests to “web” servers. Because of how it works, the web proxy server 11b is called upon to initiate a large number of connections to other servers 11a when a plurality of users submit requests to it simultaneously. The fact of initiating a large number of connections in a short period of time may resemble a “port scan” attack and therefore legitimize alarms.

When in this instance the attacker entity is a web proxy server 11b, the alarms are false alarms. Thus a nominative relationship or a rule may be defined to the effect that a profile of the “web proxy” type generates, in the role of attacker, attacks called “port scans”.

Furthermore, depending on the architecture of the network or the knowledge that a security operator has of the network, a rule or qualitative relationship may be added defining the fact that the entity in question is a “web proxy” 11b. Given these two rules, the false alarm suppression module 23 is able to qualify as “false alarms” alarms that implicate the entity in question as the attacker effecting “port scans”.

Moreover, and still because of how it works, the web proxy server 11b is not the real victim of an attack, since its function consists only in relaying requests. However, from the point of view of an intrusion detection sensor 13a, 13b, 13c, a given entity 11b having a web proxy profile is the victim of the attack. A large number of alarms of the “web attack against given entity” are therefore generated by the intrusion detection sensors 13a, 13b, 13c. Accordingly, a nominative relationship of the “web proxies are victims of web attacks” type may be added, so that the false alarm suppression module 23 qualifies attacks of this kind as false alarms.

Accordingly, an entity may be a host or server 11a, 11b of a protected information network or system 1. Moreover, these entities 11a, 11b may alternate as attacker and victim, so that an attacker or victim profile can be defined.

According to the invention, given a set of alarms A, a set of entities H, a set of attack names N, a set of profiles P, and a set Q={attacker, victim} designating the kind of profile defined, the following relationships and functions may be defined:

ATTACK: A→N associates an attack name a with an alarm a;
ATTACKER: A→H associates with an alarm a an entity h with the quality q of attacker;
VICTIM: A→H associates an entity h with the quality q victim with an alarm a;
ISεH×P associates entities and profiles with each other;
GENERATESε=Q×P×N associates the profiles with the attack names taking account of their quality q (attacker, victim).

Accordingly, the set “IS[h] ” designates the set of profiles possessed by the entity h and the expression “(q,p,α)εGENERATES” indicates that the profile p generates attacks α with quality q.

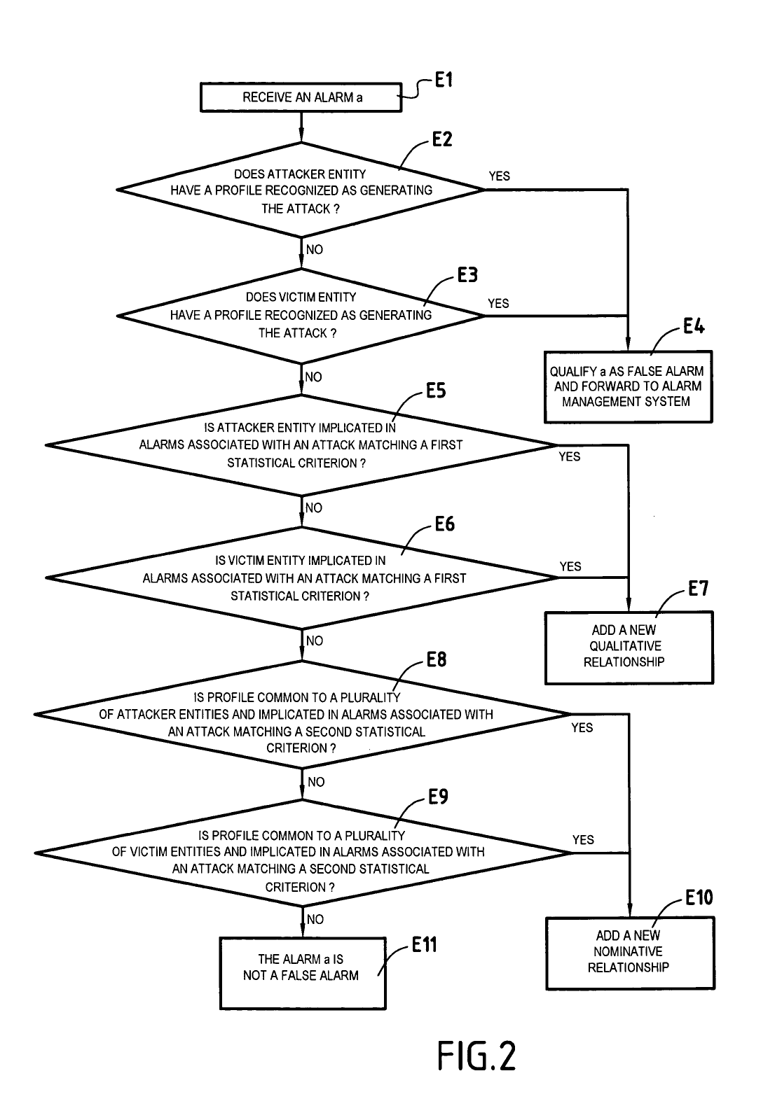

FIG. 2 is a flowchart showing the steps of the method of suppressing false alarms among alarms 31 issued by intrusion detection sensors 13a, 13b, 13c of a protection system 2.

In a step E1, the false alarm suppression module 23 receives a given alarm 31 denoted a from an intrusion detection sensor 13a, 13b, 13c and proceeds to execute the following steps.

Steps E2 to E4 qualify the given alarm a as a false alarm if the entity 9, 11a, 11b implicated in the given alarm has a profile recognized as generating the attack associated with that given alarm.

The step E2 tests if the attacker entity 9, 11a, 11b has a profile recognized as generating the attack referenced in the alarm, in which case the alarm is qualified as a false alarm in the step E4. Consequently, taking account of the above definitions, the test of the step E2 may be expressed as follows:

If ∃pεIS[ATTACKER(a)] such that (attacker,p,ATTACK(a))εGENERATES, then the next step is the step E4, in which the false alarm suppression module 23 qualifies the alarm a as a false alarm before forwarding it to the alarm management system 15.

If not, the step E3 tests if the victim entity 9, 11a, 11b has a profile recognized as generating the attack referenced in the alarm, in which case the alarm is qualified as a false alarm in the step E4. In other words:

If ∃pεIS[VICTIM(a)] such that (victim,p,ATTACK(a))εGENERATES, then the next step is the step E4.

If not, i.e. if the given entity does not have a profile recognized as generating the given attack, then steps E5 to E7 follow. These steps define qualitative relationships between the entities 9, 11a, 11b of the protected information system 1 and a set of profiles.

The qualitative relationships are defined by the false alarm suppression module 23 by successively inferring new qualitative relationships.

Accordingly, if a given entity 9, 11a, 11b is implicated in alarms associated with a given attack according to a first statistical criterion depending on the parameters of the false alarm suppression module 23, and given that this given entity does not have a profile recognized as generating the given attack, then the false alarm suppression module 23 infers a new qualitative relationship by assigning said profile recognized as generating the attack to said given entity.

For example, the first statistical criterion may comprise a test that verifies if the frequency of alarms implicating the given entity 9, 11a, 11b is above a threshold frequency for alarms associated with the given attack. The alarm threshold is advantageously left for the security operator to set and may any number less than 1, for example a number from 0.2 to 1.

More particularly, if the outcome of the test of the step E3 is negative, then the next step is the step E5 in which qualitative relationships between entity profiles and the entities 9, 11a, 11b are added. Accordingly, if the attacker entity does not have a profile recognized as generating the attack and that entity is referenced, for example, in a large number of alarms referencing the attack in question, then the false alarm suppression module infers that the entity has the profile generating the attack.

A false alarm is highly probable if an entity 9, 11a, 11b is implicated in a large number of alarms, for example. This inference may be proposed to the security operator, who can confirm it, in which case the association between the entity and the profile is stored in the memory means 27. The alarm is then qualified as a false alarm and forwarded to the alarm management system 15. If the security operator invalidates all the facts proposed, the alarm is forwarded as it stands to the alarm management system 15.

The test of the step E5 may then be formulated as follows:

$$If ∃ p ∈ P \text{:} ( attacker , p , ATTACK ( a ) ) ∈ GENERATES , \\ and$$

$$\frac{\vert \{ \begin{matrix}o ∈ A \text{:} ATTACKER ( o ) = \\ ATTACKER ( a ) ⋀ ATTACK ( o ) = ATTACK ( a )\end{matrix} \} \vert}{\vert A \vert} > τ$$

then the next step is the step E7 in which the new relationship (ATTACKER(a),p) is added to the set IS of qualitative relationships, where applicable after confirmation by the security operator. It will be noted that the expression |E| designates the number of elements of any set E.

Otherwise, the next step is the step E6, which is similar to the step E5, but relates to victim entities. Accordingly, the test of the step E6 may be formulated as follows:

$$If ∃ p ∈ P \text{:} ( victim , p , VICTIM ( a ) ) ∈ GENERATES , \\ and$$

$$\frac{\vert \{ \begin{matrix}o ∈ A \text{:} VICTIM ( o ) = \\ VICTIM ( a ) ⋀ ATTACK ( o ) = ATTACK ( a )\end{matrix} \} \vert}{\vert A \vert} > τ$$

then the next step is the step E7 in which the new relationship (VICTIM(a),p) is added to the set IS of qualitative relationships, where applicable after confirmation by the security operator.

If not, that is to say if the outcome of the test of the step E6 is negative, then steps E8 to E10 follow. Those steps define nominative relationships between the set of profiles and a set of names of attacks that this set of profiles is recognized as generating.

The false alarm suppression module 23 defines the nominative relationships by successively inferring new nominative relationships.

Then, if a given profile is common to a plurality of entities 9, 11a, 11b implicated in alarms associated with a particular attack according to a second statistical criterion depending on the parameters of the false alarm suppression module 23, and given that there is no profile recognized as generating that particular attack, then the false alarm suppression module 23 infers a new nominative relationship by allocating said particular attack to said given profile.

For example, the second statistical criterion may comprise a test that verifies whether the frequency of the particular attack is higher than an attack threshold frequency ν. The attack threshold frequency ν is advantageously left for the security operator to set and may be any number less than 1, for example a number from 0.2 to 1.

More particularly, the step E8 adds nominative relationships between profiles recognized as generating attacks and attack names. If the attack referenced in an alarm is frequent, for example, then the false alarm suppression module 23 infers that the profiles common to the set of entities implicated as attackers in alarms referencing the attack in question may be added as generators of the attack (attacker role).

A false alarm caused by a particular profile is very probable if an attack is frequent. The alarm is then qualified as a false alarm and is forwarded to the alarm management system 15. If the operator invalidates all the facts proposed, the alarm is forwarded to the alarm management system 15 as it stands.

The test of the step E8 may then be formulated as follows:

$$If \frac{\vert A ( a ) \vert}{\vert A \vert} > v , \\ where A ( a ) = \{ o ∈ A \text{:} ATTACK ( a ) = ATTACK ( o ) \}$$

then the next step is the step E10, in which the new relationship

(attacker,p,ATTACK(a))

is added, where appropriate after confirmation by the security operator, to the set GENERATES of nominative relationships for each p such that

ATTACKER(A)⊂{hεH: (h,p)εIS}.

If not, the next step is the step E9, which is similar to the step E8, but relates to victim entities. Thus the test of the step E9 may be formulated as follows:

$$If \frac{\vert A ( a ) \vert}{\vert A \vert} > v , \\ where A ( a ) = \{ o ∈ A \text{:} ATTACK ( a ) = ATTACK ( o ) \}$$

then the next step is the new step E10, in which to the new relationship

(victim,p,ATTACK(a))

is added, where appropriate after confirmation by the security operator, to the set GENERATES of nominative relationships for each p such that

VICTIM(A)⊂{hεH:(h,p)εIS}

If not, the next step is step E11 in which the alarm is forwarded as it stands to the alarm management system 15.

As a result, the false alarm suppression module 23 according to the invention provides a break point between the intrusion detection sensors 13a, 13b, 13c and the alarm management system 15 and has two types of relationship or rules available:
rules linking an entity profile to an attack name; and
rules linking an entity 9, 11a, 11b to a profile.

These rules may be supplied explicitly by the security operator of the protected information system 1 or generated automatically by the false alarm suppression module 23.

1. A method of suppressing false alarms among alarms issued by intrusion detection sensors (13a, 13b, 13c) of a protected information system (1) including entities (9, 11a, 11b) generating attacks associated with the alarms and an alarm management system (15), the method being characterized in that it comprises the following steps:
using a false alarm suppression module (23) to define qualitative relationships between the entities (9, 11a, 11b) and a set of profiles;
using the false alarm suppression module (23) to define nominative relationships between the set of profiles and a set of names of attacks which that set of profiles is recognized as generating; and
using the false alarm suppression module (23) to qualify a given alarm as a false alarm if the entity (9, 11a, 11b) implicated in the given alarm has a profile recognized as generating the attack associated with that given alarm.

2. A method according to claim 1, characterized in that each entity (9, 11a, 11b) is an attacker or a victim.

3. A method according to claim 1, characterized in that the false alarm suppression module (23) defines the qualitative relationships by successively inferring new qualitative relationships, so that if a given entity is implicated in alarms associated with a given attack according to a first statistical criterion, and if that given entity does not have a profile recognized as generating the given attack, then the false alarm suppression module (23) infers a new qualitative relationship by allocating said profile recognized as generating the given attack to said given entity.

4. A method according to claim 3, characterized in that the first statistical criterion verifies whether the frequency of alarms implicating said given entity is greater than an alarm threshold frequency associated with said given attack.

5. A method according to claim 1, characterized in that the false alarm suppression module (23) defines the nominative relationships by successively inferring new nominative relationships, so that if a given profile is common to a plurality of entities implicated in alarms associated with a particular attack according to a second statistical criterion, and there is no profile recognized as generating that particular attack, then the false alarm suppression module infers a new nominative relationship by allocating said particular attack to said given profile.

6. A method according to claim 5, characterized in that the second statistical criterion verifies whether the frequency of said particular attack is higher than an alarm threshold frequency.

7. A method according to claim 1, characterized in that the qualitative relationships are stored in a first database (27a) and the nominative relationships are stored in a second database (27b) after they are validated by a security operator.

8. A method according to claim 1, characterized in that some of the qualitative and nominative relationships are defined explicitly by the security operator.

9. A method according to claim 1, characterized in that the false alarm is forwarded to the alarm management system (15).

10. A false alarm suppression module, characterized in that it includes data processor means (25) for defining qualitative relationships between entities (9, 11a, 11b) and a set of profiles, for defining nominative relationships between the set of profiles and a set of names of attacks which that set of profiles is recognized as generating, and for qualifying a given alarm as a false alarm if the entity implicated in the given alarm has a profile recognized as generating the attack associated with that given alarm.

11. A module according to claim 10, characterized in that it further includes memory means (27) for storing the qualitative relationships in a first database (27a) and for storing the nominative relationships in a second database (27b).

12. A module according to claim 10, characterized in that it further includes an output unit (33) a security operator uses to validate the qualitative and nominative relationships.

13. A module according to claim 10, characterized in that it is connected between an alarm management system (15) and intrusion detection sensors (13a, 13b, 13c) issuing alarms associated with attacks generated by the entities (9, 11a, 11b).

14. A protected information system including entities (9, 11a, 11b), intrusion detection sensors (13a, 13b, 13c), and an alarm management system (15), characterized in that it further includes a false alarms suppression module (23) according to claim 10.

15. Intrusion detection sensor, characterized in that it is adapted to monitor attacks and to issue alarms if attacks are detected to the false alarm suppression module according claim 10.

16. Computer program designed to implement the method of suppressing false alarms according to claim 10.
